(19) United States
(12) Patent Application Publication
(10) Pub. No.: US 2026/0130423 A1
(43) Pub. Date: May 14, 2026

(54) AEROSOL-GENERATING DEVICE COMPRISING DAMPER

(71) Applicant: KT&G CORPORATION, Daejeon (KR)

(72) Inventors: Dong Sung KIM, Seoul (KR); Hwikyeong AN, Seoul (KR); Youngbum KWON, Yongin-si (KR); Yong Hwan KIM, Anyang-si (KR)

(73) Assignee: KT&G CORPORATION, Daejeon (KR)

(21) Appl. No.: 19/305,919

(22) Filed: Aug. 21, 2025

(30) Foreign Application Priority Data
Nov. 11, 2024 (KR) 10-2024-0159349

(51) Int. Cl. A24F 40/40; A24F 40/60; F16F 15/08; H02K 7/06

(52) U.S. Cl. CPC A24F 40/40; A24F 40/60; F16F 15/08; H02K 7/061

(57) ABSTRACT

An aerosol-generating device includes an actuator including a motor configured to generate a vibration associated with a device heating or a device state, an electrical line physically and electrically connected to the motor, and a motor bridge connected to the motor and surrounding the electrical line, a fixing rib including a first rib portion extending along a side of the motor, and a second rib portion extending along the motor bridge, and a damper including a first elastic portion disposed between the motor and the first rib portion, and a second elastic portion disposed between the motor bridge and the second rib portion.

### CROSS-REFERENCE TO RELATED APPLICATION

This application claims priority to Korean Patent Application No. 10-2024-0159349, filed on November 11, 2024, in the Korean Intellectual Property Office, the entire disclosure of which is incorporated herein by reference for all purposes.

### BACKGROUND

### 1. Field

The disclosure generally relates to an aerosol-generating device, for example, an aerosol-generating device including a damper.

### 2. Description of the Related Art

An aerosol-generating device is being developed that includes a motor configured to generate vibrations associated with device heating or state. The vibrations generated from the motor are transmitted to one or more components of the aerosol-generating device and may generate noise from the one or more components. The above description has been possessed or acquired by the inventor(s) in the course of conceiving the present disclosure and is not necessarily an art publicly known before the present application is filed.

### SUMMARY

An aspect of the disclosure is to provide an aerosol-generating device that reduces noise and provides a smooth vibration sensation to a user.

An aerosol-generating device includes: an actuator including a motor configured to generate a vibration associated with a device heating or a device state, an electrical line physically and electrically connected to the motor, and a motor bridge connected to the motor and surrounding the electrical line; a fixing rib including a first rib portion extending along a side of the motor, and a second rib portion extending along the motor bridge; and a damper including a first elastic portion disposed between the motor and the first rib portion, and a second elastic portion disposed between the motor bridge and the second rib portion.

The first elastic portion may extend along an entire circumference of the motor.

The first elastic portion may be configured to come into contact with the first rib portion.

The first elastic portion may be configured to elastically deform and be closely engaged with the motor.

The second elastic portion may extend along an entire side of the motor bridge.

The second elastic portion may be separated from the second rib portion with a gap therebetween.

The second elastic portion may be separated from the motor bridge with a gap therebetween.

The damper may further include a third elastic portion disposed on a base surface of the motor.

The damper may further include a hole disposed in the third elastic portion.

The first rib portion may extend along an entire circumference of the motor and may be connected to the second rib portion.

The aerosol-generating device may further include a housing. The motor may be disposed on an end surface of the housing.

A height of the first elastic portion from the end surface of the housing may be greater than a height of the second elastic portion from the end surface of the housing.

The second elastic portion may include a first region inclined with respect to the end surface of the housing and a second region inclined with respect to the end surface of the housing. An inclination of the first region may be less than an inclination of the second region.

A height of the first rib portion from the end surface of the housing may be substantially constant along a length of the first rib portion. The second rib portion may be inclined with respect to the end surface of the housing.

The aerosol-generating device may further include a fixing portion disposed on the end surface of the housing, and a connecting rib connecting the first rib portion and the fixing portion.

According to an embodiment, noise generated from the aerosol-generating device may be reduced. According to an embodiment, vibrations transmitted from a motor to other components may be attenuated. According to an embodiment, vibrations having a desired range of vibration frequencies may be transmitted to a user to provide a smooth vibration sensation. The effects of the aerosol-generating device according to an embodiment are not limited to those mentioned above, and other effects not mentioned will be clearly understood by those skilled in the art from the description below.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an aerosol-generating device according to an embodiment;

FIG. 2A shows an aerosol-generating device according to an embodiment;

FIG. 2B shows an aerosol-generating device according to an embodiment;

FIG. 3 is a side view of an aerosol-generating device according to an embodiment;

FIG. 4 is a rear perspective view of an aerosol-generating device according to an embodiment;

FIG. 5 is a rear view of an aerosol-generating device according to an embodiment;

FIG. 6 is a cross-sectional view along line 6-6 of an aerosol-generating device according to an embodiment; and

FIG. 7 is a cross-sectional view along line 7-7 of an aerosol-generating device according to an embodiment.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes "module" and "unit" are used only in consideration of facilitation of description, and do not have mutually distinguished meanings or functions. As used herein, the suffix "module" or "unit" may include a unit implemented in hardware, software, or firmware, and may be used interchangeably with other terms, for example, "logic," "logic block," "part," or "circuitry." A "module" or a "unit" may be a single integral component, or a minimum unit or part thereof, adapted to perform one or more functions. For example, the "module" or the "unit" may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms "first", "second", etc., may be used herein to describe various components, these components should not be limited by these terms. These terms are only used to distinguish one component from another component.

It will be understood that when a component is referred to as being "connected to" or "coupled to" another component, it may be directly connected to or coupled to another component, or intervening components may be present. On the other hand, when a component is referred to as being "directly connected to" or "directly coupled to" another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

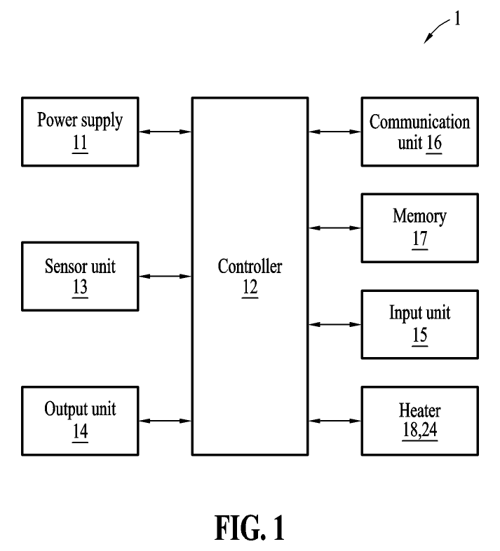

FIG. 1 is a block diagram of an aerosol-generating device according to an embodiment.

According to an embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to an embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to an embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to an embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to an embodiment, the temperature sensor may be disposed in a housing (not shown) of the aerosol-generating device 1 to detect the internal temperature of the housing (not shown).

According to an embodiment, the puff sensor may detect a user’s puff.

In an example, the puff sensor may include a pressure sensor. The pressure sensor may output a signal corresponding to the internal pressure of the aerosol-generating device 1, and the controller 12 may determine the user’s puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user’s puff occurs, temperature drop may temporarily occur in the airflow path, a space into which an aerosol-generating article is inserted (hereinafter referred to as an "insertion space"), and the heater 18 and 24. The controller 12 may determine the user’s puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user’s puff occurs, a temperature change and/or aerosol flow may occur in the insertion space of the aerosol-generating article, and accordingly, a dielectric constant in the insertion space may change. The controller 12 may determine the user’s puff based on a signal corresponding to the dielectric constant in the insertion space output from the capacitance sensor.

The puff sensor is not limited to the examples described above, and may be implemented as various sensors for detecting the user’s puff.

According to an embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to an embodiment, the insertion detection sensor may include a switch or the like for detecting pressing by the aerosol-generating article.

According to an embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to an embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to an embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to an embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to an embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to an embodiment, the movement detection sensor may detect movement of the aerosol-generating device 1. The movement detection sensor may be implemented as at least one of an acceleration sensor or a gyro sensor.

According to an embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors may be intuitively deduced by those skilled in the art from the names thereof, and thus detailed descriptions thereof may be omitted.

According to an embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to an embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a "removable battery"). The removable battery may be mounted in a battery accommodation portion provided in the aerosol-generating device 1 or may be removed from the battery accommodation portion. The removable battery may be charged in a wired and/or wireless manner.

According to an embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to an embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to an embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to an embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to an embodiment, the input unit 15 may receive information input from the user. For example, the input unit 15 may include a touch panel, a button, a keypad, a dome switch, a jog wheel, and a jog switch.

According to an embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user’s smoking pattern.

According to an embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to an embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to an embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to an embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to an embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to an embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to an embodiment, the controller 12 may determine, based on the power profile, target power to be controlled. The controller 12 may control power supplied to the heater 18 and 24 so as to correspond to the preset target power over time.

According to an embodiment, the controller 12 may detect power supplied to the heater 18 and 24 to determine the user’s puff. In more detail, the controller 12 may control power supplied to the heater 18 and 24 using the proportional-integral-differential (PID) scheme. When the user’s puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user’s puff based on the change in the power controlled.

According to an embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to an embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to an embodiment, the controller 12 may control the supply of power to the heater 18 and 24 based on a result of the detection by the sensor unit 13.

According to an embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to an embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to an embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to an embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to an embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to an embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to an embodiment, the controller 12 may control the supply of power to the heater 18 and 24 based on the user’s puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to an embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to an embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to an embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to an embodiment, the controller 12 may control the communication unit 16 to form a communication link with an external device such as a user’s mobile terminal.

According to an embodiment, upon receiving data on authentication from an external device via the communication link, the controller 12 may release restriction on use of at least one function (e.g., a heating function) of the aerosol-generating device 1. For example, the data on authentication may include the user’s birthday, an identification number uniquely identifying the user, and whether authentication is completed by the user.

According to an embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to an embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to an embodiment, upon receiving firmware data from the external device via the communication link, the controller 12 may perform firmware update.

According to an embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user’s puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to an embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to an embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

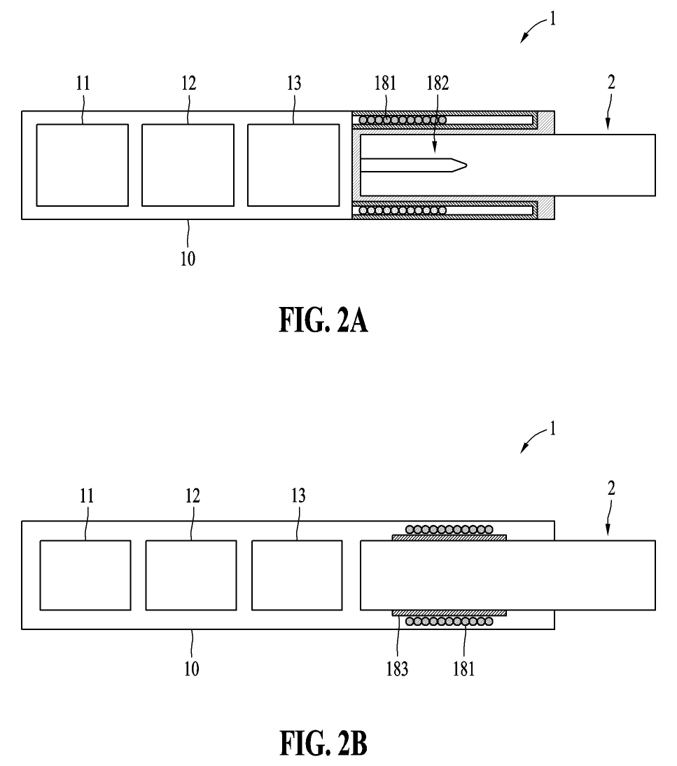

FIG. 2A shows an aerosol-generating device 1 according to an embodiment. FIG. 2B shows an aerosol-generating device 1 according to an embodiment.

According to an embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. 2A or FIG. 2B and that some of the components may be omitted or new components may be further included. The aerosol-generating device 1 shown in FIG. 2A may be referred to as an "internal heating-type" aerosol-generating device that heats the inner side of an aerosol-generating article 2. The aerosol-generating device 1 shown in FIG. 2B may be referred to as an "external heating-type" aerosol-generating device that heats the outer side of the aerosol-generating article 2. In the drawings below, a description of configurations identical to those shown in FIG. 1 will be omitted.

According to an embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to an embodiment, the heater 182 and 183 may heat the aerosol-generating article 2.

Referring to FIG. 2A, the heater 182 may be an internal heating-type heater.

According to an embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to an embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to an embodiment, the induction heater (e.g., the susceptor) (or a heater module including the same) may be disposed to be removable from the housing 10.

According to an embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to an embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 2B, the heater 183 may be an external heating-type heater.

According to an embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) with a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to an embodiment, the external heating-type heater may include an electro-resistive heater and/or an induction heater, and a description of configurations identical to those shown in FIG. 2A will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to an embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2A or FIG. 2B, both the heater 182 in FIG. 2A and the heater 183 in FIG. 2B may be included in the aerosol-generating device 1. In this case, the heater 182 may heat the inner side of the aerosol-generating article 2, and the heater 183 may heat the outer side of the aerosol-generating article 2.

According to an embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user’s oral cavity together with the introduced air through the upper end (i.e., downstream side) of the aerosol-generating article 2.

As used herein, terms such as "substantially," "approximately," "generally," and "about" when referring to a given parameter, property, or condition may include the extent to which a person of ordinary skill in the art would understand the given parameter, property, or condition to be satisfied with a small degree of variance, such as within acceptable manufacturing tolerances. For example, a particular parameter that is substantially satisfied may be at least 90% satisfied, at least 95% satisfied, or at least 99% satisfied.

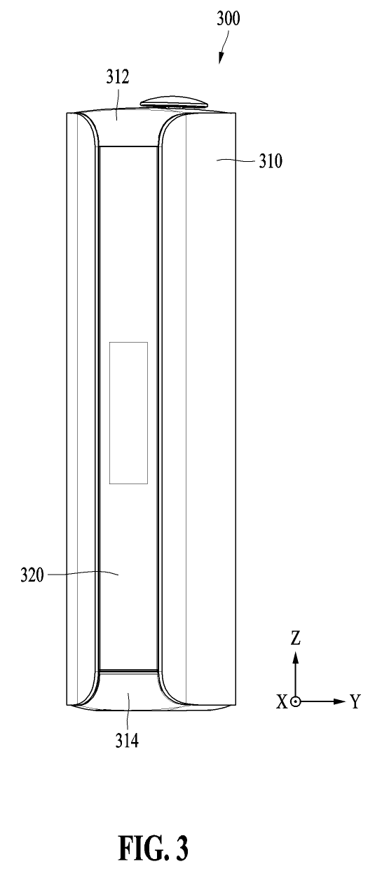

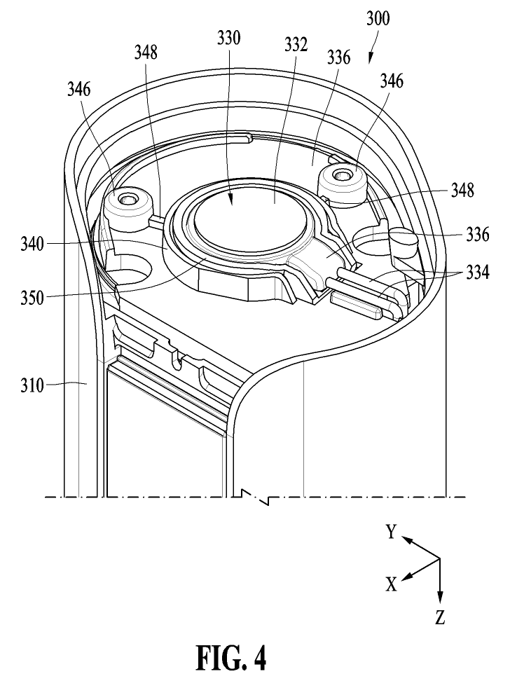

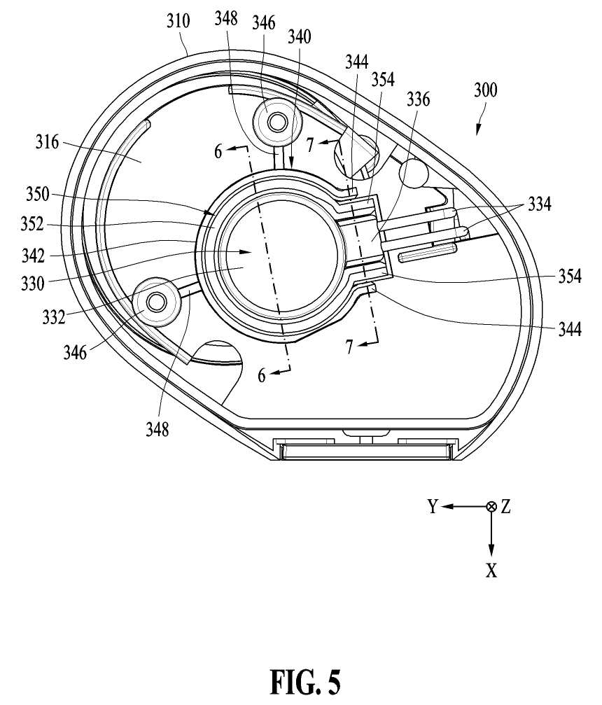

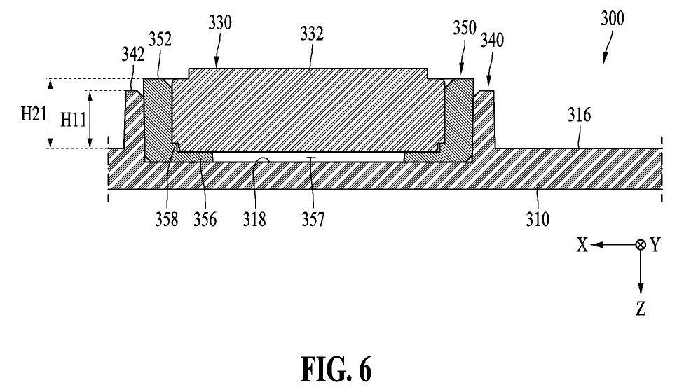

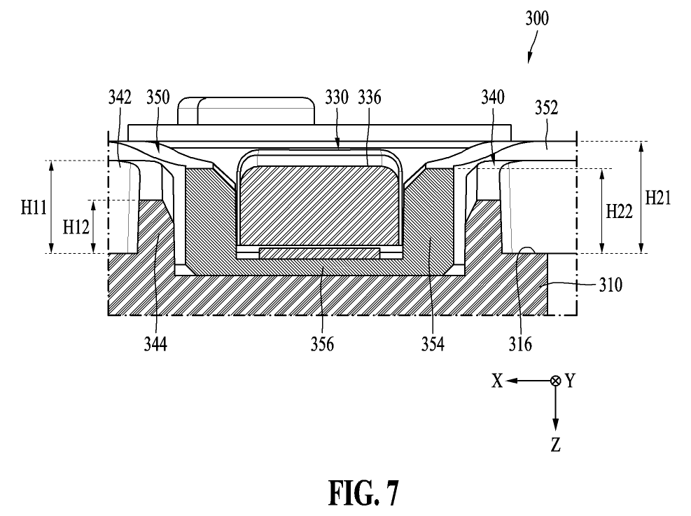

FIG. 3 is a side view of an aerosol-generating device according to an embodiment. FIG. 4 is a rear perspective view of an aerosol-generating device according to an embodiment. FIG. 5 is a rear view of an aerosol-generating device according to an embodiment. FIG. 6 is a cross-sectional view along line 6-6 of an aerosol-generating device according to an embodiment. FIG. 7 is a cross-sectional view along line 7-7 of an aerosol-generating device according to an embodiment.

Referring to FIGS. 3 to 7, an aerosol-generating device 300 may include an actuator 330 configured to generate a vibration associated with a device heating or a device state. For example, the actuator 330 may include an actuator configured to generate a vibration less than a particular frequency band, or an actuator (e.g., a haptic actuator) configured to generate a vibration greater than or equal to a particular frequency band. The aerosol-generating device 300 may reduce noise between interconnected components and provide a smooth vibration sensation to a user while the vibration generated from the actuator 330 is transmitted to the user through one or more components directly or indirectly connected to the actuator 330.

The aerosol-generating device 300 may include a housing 310. The housing 310 may be configured to accommodate at least one component (e.g., a heater) associated with the aerosol-generating device 300. The housing 310 may include a first cover 312 disposed on a first end surface (e.g., a +Z direction surface or a mouth end surface) and a second cover 314 disposed on a second end surface 316 (e.g., a -Z direction surface or a device end surface).

The aerosol-generating device 300 may include a window 320. The window 320 may include a glass material. A display disposed in the housing 310 may be visible through the window 320.

The aerosol-generating device 300 may include the actuator 330. The actuator 330 may be disposed on the second end surface 316 of the housing 310. Disposing the actuator 330 on the second end surface 316 of the housing 310 may allow the aerosol-generating device 300 to be designed to a desired size while meeting requirements of components such as a battery and a heater disposed in the housing 310.

The actuator 330 may include a motor 332 configured to generate a vibration associated with a device heating or state, a plurality of electrical lines 334 physically and electrically connected to the motor 332, and a motor bridge 336 extending from the motor 332 in a radial direction of the motor 332 and surrounding the plurality of electrical lines 334. The plurality of electrical lines 334 may lead from the motor 332 along the second end surface 316 to a printed circuit board disposed within the housing 310. The motor bridge 336 may at least partially protect the plurality of electrical lines 334 that may be exposed to an outside of the housing 310.

The aerosol-generating device 300 may include a fixing rib 340 configured to fix the actuator 330 to the housing 310. The fixing rib 340 may include a first rib portion 342 extending along a side surface (e.g., a circumferential surface with respect to a Z-axis) of the motor 332, and a plurality of second rib portions 344 respectively connected to both ends of the first rib portion 342 and extending along both side surfaces of the motor bridge 334.

The first rib portion 342 may extend along an entire circumference of a side surface of the motor 332. The first rib portion 342 may be continuous. The first rib portion 342 may include a plurality of segments. The plurality of second rib portions 344 may partially surround a side surface of the motor bridge 334. The first rib portion 342 and the plurality of second rib portions 344 may secure the motor 332 and the motor bridge 334 in place.

The first rib portion 342 and the plurality of second rib portions 344 may protrude from the second end surface 316 of the housing 310. The first rib portion 342 and the plurality of second rib portions 344 may be seamlessly connected integrally with the second end surface 316.

A first height H11 of the first rib portion 342 from the second end surface 316 of the housing 310 may be substantially constant along an entire length of the first rib portion 342. A second height H12 of the second rib portion 344 from the second end surface 316 of the housing 310 may be varied along an entire length of the second rib portion 344. For example, the second height H12 may be the greatest at a point of the second rib portion 344 connected to an end of the first rib portion 342 and may decrease in a direction away from that point. The first height H11 may be substantially equal to or greater than the second height H12. The first rib portion 342 may be substantially parallel to the second end surface 316. The second rib portion 344 may be inclined with respect to the second end surface 316.

The aerosol-generating device 300 may include a fixing portion 344 configured to fix the fixing rib 340 to the housing 310, and a connecting rib 346 connecting the fixing portion 344 and the fixing rib 340. For example, the fixing portion 344 may include a mount protruding from the second end surface 316 of the housing 310 and a screw coupled to the mount, and the mount may include a hole having an internal thread, and the screw may include an external thread that engages the internal thread. The connecting rib 346 may extend outward from an outer side surface of the first rib portion 342. A height of the connecting rib 346 may be less than a height of the first rib portion 342. The aerosol-generating device 300 may include a plurality of the fixing portions 344 and a plurality of the connecting ribs 346.

The aerosol-generating device 300 may include a damper 350 configured to reduce noise that may occur while vibration generated from the actuator 330 is transmitted to a user through one or more other components and attenuate vibration transferred from the actuator 330 to another component. For normal operation of the motor 332, an elastic material (e.g., a high-density polyurethane foam (PORON)) and a structure partially overlapping an upper end and lower end of the motor 332 may generate vibration having a rotational component from the motor 332. Thus, preventing rotation of the motor bridge 334 may be required. The damper 350 may be advantageous in providing a smooth vibration sensation to the user by allowing vibration having a frequency specified in the actuator 330 to be transmitted to the user.

The damper 350 may include a first elastic portion 352 disposed between the motor 332 and the first rib portion 342, and a plurality of second elastic portions 354 respectively connected to both ends of the first elastic portion 352 and disposed between each side surface of the motor bridge 334 and the second rib portion 344. The damper 350 may surround the motor 332 as well as the motor bridge 334, so that when a vibration of a rotational component occurs from the motor 332, the motor bridge 334 physically connected to the motor 332 rotates about a rotational axis (e.g., the Z-axis) of the motor 332, thereby preventing contact between the motor bridge 334 and the second rib portions 344, and reducing noise that may occur between the actuator 330 and the fixing rib 340.

The first elastic portion 352 may be disposed only between a side surface of the motor 332 and an inner surface of the first rib portion 342. The first elastic portion 352 may extend along an entire circumference of a side surface of the motor 332. The first elastic portion 352 may be continuous.

Each of the second elastic portions 354 may be disposed only between a side surface of the motor bridge 334 and an inner surface of the second rib portion 344. Each of the second elastic portions 354 may surround an entire side surface of the motor bridge 334.

The damper 350 may include a third elastic portion 356 disposed between the motor 332 and a recess 318 in the second end surface 316. The third elastic portion 356 may serve as a base portion and connect the first elastic portion 352 and the second elastic portion 354. The first elastic portion 352, the second elastic portion 354 and the third elastic portion 356 may define an inner hollow volume configured to at least partially accommodate the motor 332 and the motor bridge 334. The first elastic portion 352, the second elastic portion 354 and the third elastic portion 356 may be integrally and seamlessly connected.

The damper 350 may include a hole 357 disposed in the third elastic portion 356. The hole 357 may be disposed in a partial area of the third elastic portion 356 between the motor 332 and the recess 318. The hole 357 may increase a space in which the damper 350 may elastically deform.

When the first elastic portion 352 is coupled with the motor 332, the first elastic portion 352 may be elastically deformed (e.g., compressed) and closely engaged (e.g., without a gap) with a side surface of the motor 332 to the extent that the first elastic portion 352 overlaps the motor 332 before the first elastic portion 352 is elastically deformed. A surface of the first elastic portion 352 in contact with the motor 332 may elastically move toward a surface where the first elastic portion 352 contacts the first rib portion 342. In a state where the first elastic portion 352 is closely engaged with the side surface of the motor 332, a step portion 358 engaging the shape of the motor 332 may be formed between the first elastic portion 352 and the third elastic portion 356.

The second elastic portion 354 and the motor bridge 336 may be spaced apart from each other with a gap. The second elastic portion 354 and the second rib portion 344 may be spaced apart from each other with a gap therebetween. The gap between the second elastic portion 354 and the second rib portion 344 may be substantially equal to or greater than a gap between the second elastic portion 354 and the motor bridge 336. When vibration occurs from the motor 332, the clearance between the second elastic portion 354 and the second rib portion 344 may reduce vibration transmission from the motor 332 via the motor bridge 336 to the second rib portion 344.

The damper 350 may include an elastically deformable material. For example, the damper 350 may include rubber.

A third height H21 of the first elastic portion 352 from the second end surface 316 of the housing 310 may be substantially constant along an entire length of the first elastic portion 352. The first elastic portion 352 may be substantially parallel to the second end surface 316. A fourth height H22 of the second elastic portion 354 from the second end surface 316 of the housing 310 may be varied along an entire length of the second elastic portion 354. For example, the second elastic portion 354 may include a first region connected to the first elastic portion 352 and having a variable height and inclined with respect to the second end surface 316, and a second region connected to the first region and having a decreasing height and inclined with respect to the second end surface 316. An inclination of the first region may be less than an inclination of the second region. As another example, the first region may have a substantially constant height, and the second region may have a variable height. The third height H21 may be substantially equal to or less than the fourth height H22.

Certain embodiments or other embodiments of the disclosure described above are not mutually exclusive or distinct from each other. Any or all elements of the embodiments of the disclosure described above may be combined with another or combined with each other in configuration or function.

For example, a configuration "A" described in one embodiment of the disclosure and the drawings and a configuration "B" described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device, comprising:
an actuator comprising:
a motor configured to generate a vibration associated with a device heating or a device state,
an electrical line physically and electrically connected to the motor, and
a motor bridge connected to the motor and surrounding the electrical line;
a fixing rib comprising:
a first rib portion extending along a side of the motor, and
a second rib portion extending along the motor bridge; and
a damper comprising:
a first elastic portion disposed between the motor and the first rib portion, and
a second elastic portion disposed between the motor bridge and the second rib portion.

2. The aerosol-generating device of claim 1, wherein the first elastic portion extends along an entire circumference of the motor.

3. The aerosol-generating device of claim 1, wherein the first elastic portion is configured to come into contact with the first rib portion.

4. The aerosol-generating device of claim 1, wherein the first elastic portion is configured to elastically deform and be closely engaged with the motor.

5. The aerosol-generating device of claim 1, wherein the second elastic portion extends along an entire side of the motor bridge.

6. The aerosol-generating device of claim 1, wherein
the second elastic portion is separated from the second rib portion with a gap therebetween.

7. The aerosol-generating device of claim 1, wherein the second elastic portion is separated from the motor bridge with a gap therebetween.

8. The aerosol-generating device of claim 1, wherein the damper further comprises a third elastic portion disposed on a base surface of the motor.

9. The aerosol-generating device of claim 8, wherein the damper further comprises a hole disposed in the third elastic portion.

10. The aerosol-generating device of claim 1, wherein the first rib portion extends along an entire circumference of the motor and is connected to the second rib portion.

11. The aerosol-generating device of claim 1, further comprising a housing,
wherein the motor is disposed on an end surface of the housing.

12. The aerosol-generating device of claim 11, wherein a height of the first elastic portion from the end surface of the housing is greater than a height of the second elastic portion from the end surface of the housing.

13. The aerosol-generating device of claim 11, wherein the second elastic portion comprises:
a first region inclined with respect to the end surface of the housing; and
a second region inclined with respect to the end surface of the housing,
wherein an inclination of the first region is less than an inclination of the second region.

14. The aerosol-generating device of claim 11, wherein a height of the first rib portion from the end surface of the housing is substantially constant along a length of the first rib portion, and
wherein the second rib portion is inclined with respect to the end surface of the housing.

15. The aerosol-generating device of claim 11, further comprising:
a fixing portion disposed on the end surface of the housing; and
a connecting rib connecting the first rib portion and the fixing portion.
